(19) United States
(12) Patent Application Publication
(10) Pub. No.: US 2020/0122779 A1
(43) Pub. Date: Apr. 23, 2020

(54) FENDER APRON FOR VEHICLE

(71) Applicants: HYUNDAI MOTOR COMPANY, Seoul (KR); KIA MOTORS CORPORATION, Seoul (KR)

(72) Inventors: Do Hoi KIM, Anyang-si (KR); Dong Kyu KIM, Suwon-si (KR)

(21) Appl. No.: 16/265,649

(22) Filed: Feb. 1, 2019

(30) Foreign Application Priority Data
Oct. 17, 2018 (KR) 10-2018-0123836

(51) Int. Cl. B62D 25/16; B62D 27/02

(52) U.S. Cl. CPC B62D 25/16; B62D 27/02

(57) ABSTRACT

A fender apron for a vehicle has a hollow cross-section, and includes: a rear end connected to a lower end of an A pillar, extending forwards, and bent in a curved shape around a shock absorber housing; and an extending front end extending to and fixed to a side surface of a front side member.

### CROSS REFERENCE TO RELATED APPLICATION

The present application claims priority to Korean Patent Application No. 10-2018-0123836, filed Oct. 17, 2018, the entire contents of which is incorporated herein for all purposes by this reference.

### TECHNICAL FIELD

The present disclosure relates to a fender apron for a vehicle, and more particularly, to a fender apron for a vehicle that connects an A pillar, a cowl part, and a front side member by a single member without any additional members in a front vehicle body structure of a vehicle.

### BACKGROUND

Generally, a front vehicle body structure of a vehicle is positioned in front of the vehicle, so that when the vehicle collides in a forward direction, the front vehicle body structure of the vehicle is first subjected to a collision load to mitigate an impact, thus performing a function as a structure for forming an engine room of the vehicle and a function of protecting an occupant from a forward collision.

In the front vehicle body structure of the related art, a front side member formed in a longitudinal direction of the vehicle, a cowl part located at an upper end of the engine room, and an A pillar are generally connected by coupling a plurality of components. The existing structure based on the multiple components may have excellent performance but a weight of the vehicle is increased and production cost is increased due to the large number of components.

Therefore, in order to form a front vehicle body of a vehicle, a novel structure which is reduced in the number of components, compared with the existing structure, and which is capable of maintaining performance against a collision is required.

The description provided above as a related art of the present disclosure is only for helping understanding the background of the present disclosure and should not be construed as being included in the related art known by those skilled in the art.

### SUMMARY

An object of the present disclosure is to provide a fender apron for a vehicle that connects an A pillar, a cowl part, and a front side member by only a single member without any additional members in a front vehicle body structure of a vehicle.

According to an embodiment of the present disclosure, a fender apron for a vehicle has a hollow cross-section, and comprises: a rear end portion connected to a lower end portion side of an A pillar, extending forwards, and bent in a curved shape around a shock absorber housing; and an extending front end portion extending to and fixed to a side surface of a front side member.

The fender apron may include an upper outer panel and a lower inner panel, and both end portions of the outer panel and the inner panel may be welded to have a shape of one connected member.

The fender apron may include a rear member in which a rear end portion is connected to a lower end portion side of the A pillar and extending forwards, an extending member extending forwards from the rear member and covering a side surface of the shock absorber housing, and a front member extending forwards from the extending member and having a front end portion connected to a side surface of the front side member.

The rear member of the fender apron may be coupled with a cowl side panel in which a side end portion of the vehicle in an inward direction closes a side surface of a cowl part.

The rear member of the fender apron may include an upper outer panel and a lower inner panel, and end portions of the outer panel and the inner panel in an inward direction of the vehicle may be fixed together with a cowl side panel.

An extending member of the fender apron may be configured such that a rear end portion thereof may extend from a front end of the rear member and may be coupled to the cowl side panel which closes a side surface of the cowl part, and a side end portion of a front end portion thereof in an inward direction of the vehicle may be coupled to a side surface of a shock absorber housing.

The extending member of the fender apron may include an upper outer panel and a lower inner panel, and end portions of the outer panel and the inner panel in an inward direction of the vehicle at a front end portion of the extending member may be fixed together to the shock absorber housing.

A rear end portion of the front member of the fender apron may extend from a front end of the extending member, may be coupled to a side surface of the shock absorber housing, and may be bent to extend in a curved shape in an inward direction of the vehicle, and a front end portion thereof may be connected to a side surface of the front side member.

An engine mounting bracket may be installed at an upper end of the front side member, and a front end portion of the front member of the fender apron may be coupled together to the front side member and the engine mounting bracket.

A front end portion of the front member of the fender apron may be coupled to a front end portion of the engine mounting bracket, a housing side reinforcing panel may be coupled to a rear end portion of the engine mounting bracket, an upper end of the housing side reinforcing panel may be connected to a side end of the front member in an inward direction of the vehicle and extends downwards, a rear end of an extending portion of the housing side reinforcing panel may be connected along a front edge of the shock absorber housing, and a lower end may be connected to a rear end portion of the engine mounting bracket.

A space may be formed between the front member of the fender apron and the shock absorber housing, and the housing side reinforcing panel may be formed on a rear side of the space.

The rear member, the extending member, and the front member of the fender apron may each include the upper outer panel and the lower inner panel, both end portions of the outer panels and the inner panels may be welded to form a partial hollow member, and the end portions of the rear member, the extending member, and the front member may be connected to form a single extending member.

### BRIEF DESCRIPTION OF THE DRAWINGS

FIG. 1 is a view illustrating a state in which a fender apron for a vehicle is connected according to an embodiment of the present disclosure;

FIG. 2 is a plan view illustrating a state in which a fender apron for a vehicle is connected according to an embodiment of the present disclosure;

FIG. 3 is a side view illustrating a state in which a fender apron for a vehicle is connected according to an embodiment of the present disclosure; and

FIG. 4 is a cross-sectional view taken along line A- A of the fender apron for a vehicle of FIG. 2.

### DETAILED DESCRIPTION OF THE EMBODIMENTS

Hereinafter, a fender apron for a vehicle according to embodiments of the present disclosure will be described with reference to the accompanying drawings.

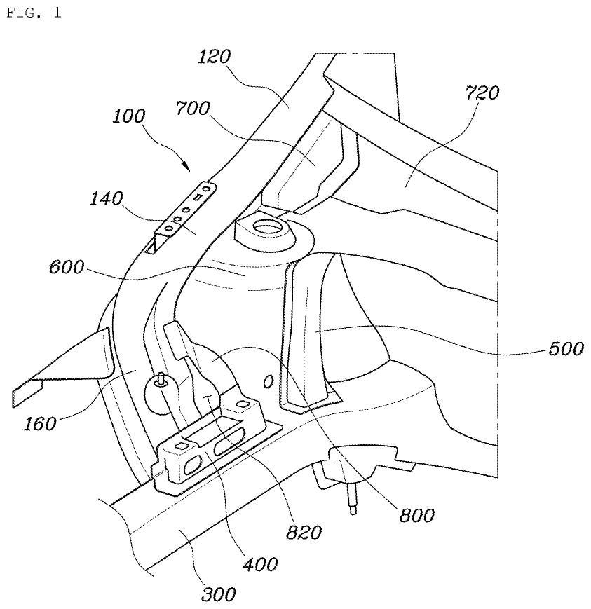

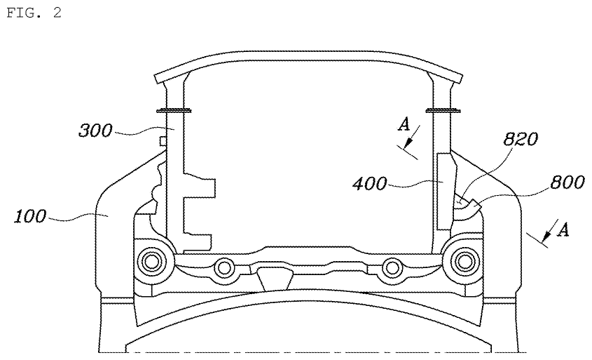

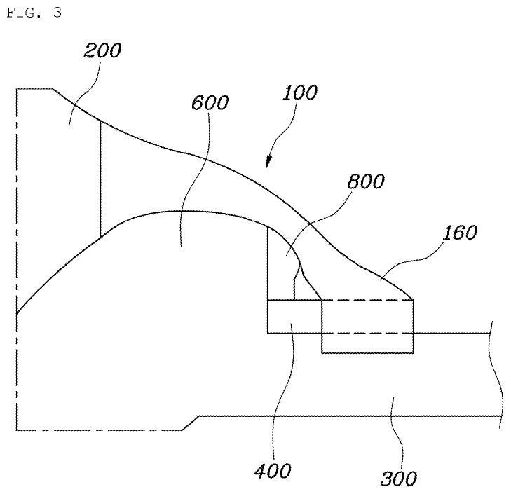

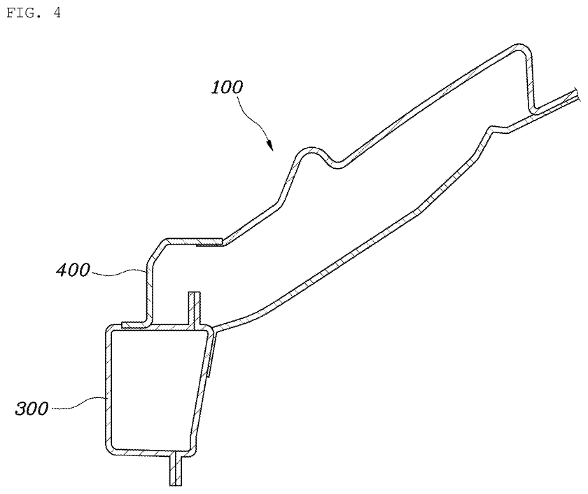

FIG. 1 is a view illustrating a state in which a fender apron for a vehicle is connected according to an embodiment of the present disclosure, FIG. 2 is a plan view illustrating a state in which a fender apron for a vehicle is connected according to an embodiment of the present disclosure, FIG. 3 is a side view illustrating a state in which a fender apron for a vehicle is connected according to an embodiment of the present disclosure, FIG. 4 is a cross-sectional view taken along line A-A of the fender apron for a vehicle of FIG. 2, and FIG. 5 is a cross-sectional view taken along line C-C of the fender apron for a vehicle of FIG. 1.

A fender apron 100 for a vehicle according to the present disclosure is in the form of a member having a hollow cross-section. A rear end portion of the fender apron 100 is connected to a lower end portion side of an A pillar 200, extends forwards, and is bent in a curved shape to turn at a shock absorber housing 600, and an extending front end portion extends to and fixed to a side surface of a front side member 300. Accordingly, the fender apron 100 is bent in a curved shape and serves to connecting a lower end portion of the A pillar 200, the shock absorber housing 600, and the front side member 300 by the single member. In this manner, since the fender apron 100 has the structure of connecting the front vehicle body structure by only the single member, it serves to maintain performance with respect to collision stability of the vehicle, while the number of components is reduced. Further, the fender apron 100 for a vehicle may be connected from the shock absorber housing 600 to the front side member 300 without a separate reinforcing panel or a reinforcing member.

In the related art, the fender apron has the shape of a member, but the related art fender apron extends linearly forwards from a lower end portion side of the A pillar, and a front end portion of the fender apron is connected to the front side member through a plurality of panels. In this case, a load path is not properly foiled between the front side member and the fender apron. As a result, a plurality of reinforcement panels are added to the front side member and the fender apron, whereby a certain extent of collision stiffness may be ensured but a weight of the front side portion of the vehicle is increased. In order to fundamentally solve such a problem, the fender apron extends in a curved shape and connected to the front side member to thereby reliably form a load path together with the front side member and thus eliminate the reinforcement panel, and the like, to reduce the weight.

Specifically, in order to product a single connected vehicle body structure member of a vehicle, in the present disclosure, the fender apron 100 for a vehicle includes an upper outer panel and a lower inner panel with respect to a height direction of the vehicle. A coupling member of the upper outer panel and the lower output panel has a shape of a member having a hollow cross-section. Each of the outer panel and the inner panel may be formed through a press method, and both end portions of the outer panel and the inner panel are welded to have a shape of an integrally connected member.

As illustrated in FIGS. 1 and 3, the fender apron 100 for a vehicle according to the present disclosure includes a rear member 120 in which a rear end portion is connected to a lower end portion side of the A pillar 200 and extending forwards, an extending member 140 extending forwards from the rear member 120 and covering a side surface of the shock absorber housing 600, and a front member 160 extending forwards from the extending member 140 and having a front end portion connected to a side surface of the front side member 300. The fender apron 100 may be manufactured by dividing it to three members, and in this case, since the degree of bending of each member may be different, which facilitates designing for securing desired stiffness.

As illustrated in FIG. 1, a side end portion of the rear member 120 in an inward direction of the vehicle may be coupled with a cowl side panel 700 that closes a side surface of a cowl part 720. Since the rear member 120 is coupled with the cowl side panel 700, in case of a collision occurring at the front side of the vehicle, a collision load may be transmitted not only to the A pillar 200 but also to the cowl part 720 through the cowl side panel 700 in a width direction of the vehicle, and thus, collision stability may be increased.

The rear member 120 of the fender apron 100 may also include an upper outer panel and a lower inner panel, and end portions of the outer panel and the inner panel in the inward direction of the vehicle may be fixed together with the cowl side panel 700. In this manner, since the rear member 120 includes the outer panel and inner panel, it may advantageously be coupled with the cowl side panel 700 by only single welding or bonding and a collision load transmitted through the outer panel and the inner panel of the fender apron 100 may be smoothly distributed to the cowl part 720 and the A pillar 200.

As illustrated in FIG. 1, the fender apron 100 may include an extending member 140 having a rear end portion extending from a front end of the rear member 120. A rear end portion of the extending member 140 may be coupled with the cowl side panel 700 that closes the side surface of the cowl part 720, and a side end portion of a front end portion thereof in an inward direction of the vehicle may be coupled to a side surface of the shock absorber housing 600. The extending member 140 may be coupled to the shock absorber housing 600 in both longitudinal direction (L direction) of the vehicle and in height direction (H direction) through welding, whereby the extending member 140 may cover an upper side end of the shock absorber housing 600. Through such coupling, in the extending member 140, a collision load introduced through the front side member 300 may be appropriately distributed to the shock absorber housing 600, the cowl part 720, and the rear member 120, effectively preventing excessive deformation of the vehicle body.

As illustrated in FIGS. 1 and 5, the extending member 140 of the fender apron 100 may include an upper outer panel 145a and a lower inner panel 145b, and end portions of the outer panel 145a and the inner panel 145b in an inward direction of the vehicle at the front end portion of the extending member 140 is fixed together to the shock absorber housing 600. If the extending member 140 is not fixed to the shock absorber housing 600, a collision load may not be distributed and the fender apron 100 may be excessively deformed. Thus, in order to ensure reliable coupling, the extending member 140 includes the outer panel 145a and the inner panel 145b and is fixed to the shock absorber housing 600, whereby the extending member 140 may serve as a load path member and coupling strength with the vehicle body may be increased.

As illustrated in FIG. 1, in the fender apron 100, a rear end portion of the front member 160 extends from a front end of the extending member 140, the front member 160 is coupled to a side surface of the shock absorber housing 600 and bent to extend in a curved shape in an inward direction of the vehicle, and a front end portion of the front member 160 is connected to a side surface of the front side member 300. An engine mounting bracket 400 may be installed at an upper end of the front side member 300, and as illustrated in FIGS. 3 and 4, a front end portion of the front member 160 may be coupled to a side surface of the front side member 300 and the engine mounting bracket 400 together.

In the event of a vehicle collision, a front side portion of the front side member 300 in the front side vehicle body needs the ability to absorb impact through buckling at an appropriate point. In order to solve this problem, the front member 160 of the fender apron 100 is coupled to a side surface of the front side member 300, and the engine mounting bracket 400 is also coupled together to increase coupling rigidity, whereby the front end portion of the front side member 300 induce effective generation of buckling at the front side portion with respect to the engine mounting bracket 400.

Further, as illustrated in FIGS. 1 and 2, a front end portion of the front member 160 of the fender apron 100 is coupled to a front end portion of the engine mounting bracket 400, a housing side reinforcing panel 800 is coupled to a rear end portion of the engine mounting bracket 400, an upper end of the housing side reinforcing panel 800 is connected to a side end of the front member 160 in an inward direction of the vehicle and extends downwards, a rear end of an extending portion of the housing side reinforcing panel 800 is connected along a front edge of the shock absorber housing 600, and a lower end may be connected to a rear end portion of the engine mounting bracket 400. Through this coupling, the housing side panel 800 restricts a side surface of the front member 160 having a curved shape to prevent excessive deformation of the curved front member 160, and a function of distributing a collision load transmitted through the front member 160 again to the front side member 300 and the shock absorber housing 600 through the housing side panel 800 may be performed.

As illustrated in FIGS. 1 and 3, a space 820 may be formed between the front member 160 and the shock absorber housing 600, and the housing side reinforcing panel 800 may be formed on a rear side of the space 820. Compared with the related art in which the front vehicle body structure of a vehicle requires a reinforcing member such as multiple panels, or the like, in the present disclosure, the front member 160 of the fender apron 100 is directly coupled to the front side member 300 without a separate reinforcing member and the number of components may be reduced such that the space 820 is formed between the housing side reinforcing panel 800 and the front member 160 of the fender apron 100, and thus, the weight of the vehicle may be reduced and production cost of the vehicle body structure may be reduced.

As illustrated in FIGS. 1, 3 and 4, the rear member 120, the extending member 140, and the front member 160 of the fender apron 100 for a vehicle may each include the upper outer panel and the lower inner panel, both end portions of the outer panels and the inner panels are welded to form a partial hollow member, and the end portions of the rear member 120, the extending member 140, and the front member 160 are connected to form a single extending member. Accordingly, a smaller amount of the reinforcing members may be used as compared with the related art vehicle body structure, and since the fender apron 100 is directly connected from the A pillar 200 to the front side member 300, the structure of maintaining performance with respect to a collision load may be secured.

According to the fender apron for a vehicle according to the present disclosure, the A pillar, the cowl part, and the front side member may be connected by a single member without a separate member in the front vehicle body structure of the vehicle.

In particular, since the number of required parts is reduced as compared with the existing vehicle body structure, the weight of the manufactured vehicle is reduced, and accordingly, production cost of the vehicle may also be reduced. In addition, although the number of parts is reduced as compared with the existing vehicle body structure, performance against a collision at the front of the vehicle may be maintained or enhanced.

Although the present disclosure has been shown and described with respect to specific embodiments, it will be apparent to those having ordinary skill in the art that the present disclosure may be variously modified and altered without departing from the spirit and scope of the present disclosure as defined by the following claims.

What is claimed is:

1. A fender apron for a vehicle, wherein the fender apron has a hollow cross-section, the fender apron comprising:
a rear end connected to a lower end of an A pillar, extending forwards, and bent in a curved shape around a shock absorber housing; and
an extending front end extending to and fixed to a side surface of a front side member of the vehicle.

2. The fender apron of claim 1, further comprising an upper outer panel and a lower inner panel, wherein both ends of the outer panel and the inner panel are welded together as one panel.

3. The fender apron of claim 1, comprising:
a rear member, in which the rear end is connected to the lower end of the A pillar, extending forwards;
an extending member extending forwards from the rear member and covering a side surface of the shock absorber housing; and
a front member extending forwards from the extending member and having a front end connected to the side surface of the front side member.

4. The fender apron of claim 3, wherein
the rear member is coupled with a cowl side panel such that a side end of the vehicle, in an inward direction of the vehicle, closes a side surface of a cowl part.

5. The fender apron of claim 4, wherein
the rear member includes an upper outer panel and a lower inner panel, and
an end of each of the outer panel and the inner panel, in the inward direction of the vehicle, are fixed together with the cowl side panel.

6. The fender apron of claim 3, wherein
the extending member comprises:
a rear end extending from a front end of the rear member and coupled to a cowl side panel which closes a side surface of a cowl part; and
a front end having a side end, in an inward direction of the vehicle, coupled to the side surface of the shock absorber housing.

7. The fender apron of claim 6, wherein
the extending member includes an upper outer panel and a lower inner panel, such that ends of the outer panel and the inner panel, in the inward direction of the vehicle at a front end of the extending member, are fixed to the shock absorber housing.

8. The fender apron of claim 3, wherein
a rear end of the front member of the fender apron extends from a front end of the extending member, is coupled to the side surface of the shock absorber housing, and is bent to extend in a curved shape in an inward direction of the vehicle, and
the front end of the front member is connected to a side surface of the front side member.

9. The fender apron of claim 3, wherein
an engine mounting bracket is disposed on an upper end of the front side member, and
the front end of the front member is coupled to the front side member and the engine mounting bracket.

10. The fender apron of claim 9, wherein
the front end of the front member of the fender apron is coupled to a front end of the engine mounting bracket,
a housing side reinforcing panel is coupled to a rear end of the engine mounting bracket,
an upper end of the housing side reinforcing panel is connected to a side end of the front member in an inward direction of the vehicle and extends downwards,
a rear end of an extending portion of the housing side reinforcing panel is connected along a front edge of the shock absorber housing, and
a lower end of the housing side reinforcing panel is connected to a rear end of the engine mounting bracket.

11. The fender apron of claim 10, wherein
the front member of the fender apron is spaced apart from the shock absorber housing, such that the housing side reinforcing panel is disposed at a rear side of the space between the front member of the fender apron and the shock absorber housing.

12. The fender apron of claim 3, wherein
each of the rear member, the extending member, and the front member includes an upper outer panel and a lower inner panel, both ends of the outer panels and the inner panels of each of the rear member, the extending member, and the front member are welded to each other as a partial hollow member, and
ends of the rear member, the extending member, and the front member are connected to each other as a single extending member.
